(19) United States
(12) Patent Application Publication
(10) Pub. No.: US 2026/0159178 A1
(43) Pub. Date: Jun. 11, 2026

(54) VEHICLE DUCT STRUCTURE

(71) Applicants: HYUNDAI MOTOR COMPANY, Seoul (KR); KIA CORPORATION, Seoul (KR); DAEHAN SOLUTION CO.,LTD., Incheon (KR)

(72) Inventors: Ji Seob Park, Hwaseong-si (KR); Ji Ah Kim, Hwaseong-si (KR); Ji Yun Ha, Hwaseong-si (KR); Jin Ho Hwang, Hwaseong-si (KR); Choong Ho Kwon, Seoul (KR); Yong Jun Choi, Seoul (KR)

(73) Assignees: HYUNDAI MOTOR COMPANY, Seoul (KR); KIA CORPORATION, Seoul (KR); DAEHAN SOLUTION CO.,LTD., Incheon (KR)

(21) Appl. No.: 19/377,654

(22) Filed: Nov. 3, 2025

(30) Foreign Application Priority Data
Dec. 10, 2024 (KR) 10-2024-0182135

(51) Int. Cl. B62D 25/14; B60H 1/00

(52) U.S. Cl. CPC B62D 25/142; B60H 1/00564

(57) ABSTRACT

A vehicle duct structure includes: a dashboard panel having a dashboard pad; a front pad positioned to face the dashboard panel; a vehicle air conditioning system positioned inside the dashboard panel; a first duct configured to communicate with the vehicle air conditioning system; and a second duct configured to communicate with the first duct and positioned on a vehicle body floor. The dashboard pad includes a groove positioned between the vehicle air conditioning system and the second duct, and the first duct is defined by the groove and the front pad.

### CROSS-REFERENCE TO RELATED APPLICATION

This application claims under 35 U.S.C. § 119(a) the benefit of priority to Korean Patent Application No. 10-2024-0182135 filed on Dec. 10, 2024, the entire contents of which are incorporated herein by reference.

### BACKGROUND

### (a) Technical Field

The present disclosure relates to a vehicle duct structure, and more particularly, to a technology for forming a duct shape by separating a spacing between carpet portions when a front module and a center module are coupled in a modular manufacturing method.

### (b) Background Art

A vehicle air conditioning system is an essential component for efficiently circulating interior air and maintaining appropriate temperature and humidity. In modern vehicles, a technology is advancing to introduce modularization in the design of air conditioning systems and simplification of a manufacturing process in order to improve passenger comfort and energy efficiency. A duct structure in the air conditioning system is an important factor that achieves performance improvement through efficient induction of air flow and directly affects the manufacturing and assembly processes.

The conventional vehicle air conditioning system is designed to efficiently induce air flow using a heating duct and to minimize heat loss with a sealed structure for each section. This design is developed with the goal of maintaining a comfortable environment in a passenger space while securing air conditioning performance. In addition, a duct package design is to optimize an air conditioning flow inside a vehicle and to provide a better environment for passengers.

However, the related art has the following problems. First, an individual assembly and installation process of the heating duct is complicated, which results in increased manufacturing time and increased production costs. Second, the overall weight of the vehicle is increased due to an individual configuration of the heating duct, which leads to reduced fuel efficiency and reduced energy efficiency. Third, when the package design of the heating duct is not optimized, there is a problem in that heat loss occurs, which degrades air conditioning performance. Lastly, since the duct and pad are designed independently, the space utilization inside the vehicle is low. Accordingly, there is a limitation in implementing a low-floor and flatness of the vehicle.

Recently, studies on an air conditioning system duct structure based on a modular manufacturing method has been actively conducted to solve these problems of the related art.

### SUMMARY

The present disclosure has been made in an effort to solve the above-described problems associated with the prior art.

In one aspect, the present disclosure provides a duct structure that forms a duct shape by coupling a front module and a center module to separate a spacing between carpet portions, thereby providing a smooth fluid connection between an air conditioning device and a rear duct.

In addition, the present disclosure provides weight reduction and heat loss reduction by integrating functions of a duct and a pad to improve the assembly process and optimize a heating duct in a block matching portion.

Objectives of the present disclosure are not limited to the above-described objectives. Other objectives of the present disclosure, which are not described, should be more clearly understood by those having ordinary skill in the art in the technical field to which the present disclosure pertains from the following description.

A vehicle duct structure for achieving the objectives of the present disclosure includes the following configuration.

In an embodiment, the present disclosure provides a vehicle duct structure including: a dashboard panel having a dashboard pad; a front pad positioned to face the dashboard panel; a vehicle air conditioning system positioned inside the dashboard panel; a first duct configured to communicate with the vehicle air conditioning system; and a second duct configured to communicate with the first duct and positioned on a vehicle body floor. The dashboard pad includes a groove positioned between the vehicle air conditioning system and the second duct and the first duct includes, i.e., is formed or defined by the groove and the front pad.

In addition, the front pad may include a plurality of bridges extending along the first duct. The dashboard pad may include a seating groove into which one or more of the bridges are inserted.

In addition, the vehicle duct structure may further include a sealing unit configured to surround one or more of the bridges inserted into the seating groove.

In addition, the sealing unit may include a first sealing pad configured to surround an upper surface of the dashboard pad including the seating groove and may include a second sealing pad, at least a portion of which is in contact with the first sealing pad and which surrounds a lower surface of the front pad including the bridge.

In addition, the vehicle duct structure may further include the dashboard panel and a front module in which the vehicle air conditioning system, the dashboard pad, and the front pad are positioned. The first duct may be formed in the front module.

In addition, the vehicle duct structure may further include a center module including a vehicle body floor and coupled to the front module. The center module and the front module may be coupled so that the first duct and the second duct may be fluidly connected.

In addition, the vehicle duct structure may further include a front carpet in surface contact with the front pad, a center pad configured to surround the second duct, and a center carpet in surface contact with the center pad.

In an embodiment, the present disclosure provides a vehicle air conditioning system including: a front module having a dashboard panel; a vehicle air conditioning system positioned in the front module; a first duct fluidly connected to the vehicle air conditioning system; a second duct configured to communicate with the first duct and positioned on a vehicle body floor; and a center module including a vehicle body floor and coupled to the front module. The first duct is positioned on an upper end of a coupling portion positioned between the front module and the center module.

In addition, the first duct may be fluidly connected to the second duct by connecting the front module and the center module.

In addition, the first duct may be formed through a spacing between a dashboard pad positioned inside the dashboard panel and the front pad, a portion of which is in surface contact with the dashboard pad.

Other aspects and embodiments of the present disclosure are discussed herein.

It should be understood that the terms “vehicle” or “vehicular” or other similar terms as used herein is inclusive of motor vehicles in general. Such motor vehicles may encompass passenger automobiles including sports utility vehicles (SUV), buses, trucks, various commercial vehicles, watercraft including a variety of boats and ships, aircraft, and the like. Such motor vehicles may also include, hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example vehicles that are both gasoline-powered and electric-powered.

The above and other features of the present disclosure are discussed herein.

### BRIEF DESCRIPTION OF THE DRAWINGS

The above and other features of the present disclosure are described in detail with reference to certain example embodiments thereof illustrated in the accompanying drawings, which are given hereinbelow by way of illustration only, and thus are not limitative of the present disclosure, and wherein:

FIG. 1 illustrates a state in which a front module and a center module of a vehicle are coupled according to one embodiment of the present disclosure;

FIG. 2 illustrates a state in which a dashboard pad is mounted on the front module according to one embodiment of the present disclosure;

FIG. 3 illustrates a state in which a center carpet and a center pad are mounted on a center module according to one embodiment of the present disclosure;

FIG. 4A is a perspective view illustrating a first duct and a second duct, which are formed in the front module and the center module, according to one embodiment of the present disclosure;

FIG. 4B is a side cross-sectional view along line A-A of the ducts in FIG. 4A according to one embodiment of the present disclosure;

FIG. 5A illustrates a coupling structure and an airtightness structure of a dashboard pad and a front pad according to one embodiment of the present disclosure; and

FIG. 5B illustrates a coupling structure and an airtightness structure of a dashboard pad and a front pad according to another embodiment of the present disclosure.

It should be understood that the appended drawings are not necessarily drawn to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, embodiments of the present disclosure are described in more detail with reference to the accompanying drawings. Embodiments of the present disclosure can be modified in various forms, and the scope of the present disclosure should not be construed as being limited to the following embodiments. These embodiments are provided to more fully describe the present disclosure to those of ordinary skill in the art.

Further, the terms “˜part,” “˜unit,” or the like used herein mean a unit for processing at least two functions or operations, and this unit may be implemented by hardware, software, or a combination of hardware and software.

In addition, the terms used herein are for the purpose of describing only specific embodiments and are not intended to limit the present disclosure. Unless the context clearly dictates otherwise, the singular form includes the plural form.

In addition, throughout this specification, when a part is referred to as “comprising” a component, it means that other components can be further included, not excluding other components unless specifically stated otherwise. In addition, terms such as “˜portion” and the like described herein mean a unit that processes at least two functions or operations. When a component, module, unit, portion, part, member, element, apparatus, or the like of the present disclosure is described as having a purpose or performing an operation, function, or the like, the component, module, unit, portion, part, member, element, apparatus, or the like should be considered herein as being “configured to” meet that purpose or to perform that operation or function.

Hereinafter, embodiments are described in detail with reference to the accompanying drawings. In describing embodiments with reference to the accompanying drawings, the same or corresponding components are assigned the same reference numerals throughout the specification, and duplicate descriptions thereof have been omitted.

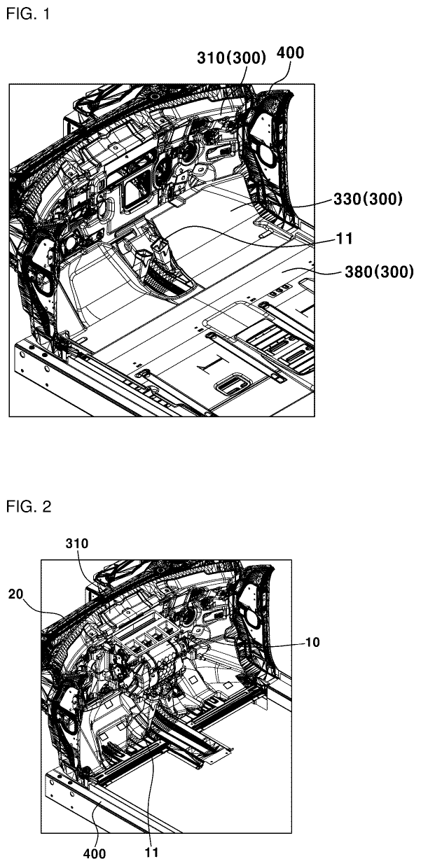

FIG. 1 is a perspective view illustrating a vehicle duct structure.

As one embodiment of the present disclosure, the vehicle duct structure includes a dashboard panel 20 having a dashboard pad 310, a front pad 210 positioned to face a dashboard panel 20, a vehicle air conditioning system 10 positioned inside the dashboard panel 20, a first duct 100 communicating with the vehicle air conditioning system 10, and a second duct 200 communicating with the first duct 100.

The vehicle air conditioning system 10 is disposed inside the dashboard panel 20 and receives air from a blowing device (not shown) positioned in an engine compartment outside the dashboard panel 20 to perform heat exchange. The vehicle air conditioning system 10 cools or heats the air supplied from the blowing device (not shown) and discharges the air to front or rear seats of the vehicle.

The first duct 100 communicating with the vehicle air conditioning system 10 may be directly connected to a rear seat vent (not shown) through which the air of the vehicle air conditioning system 10 is discharged. The first duct 100 may be connected to a hose or a rear duct 11 that is fluidly connected to the rear seat vent (not shown).

In an example, the first duct 100 includes a sealed coupling structure designed to be in close contact with an outer circumferential surface of a vent of the vehicle air conditioning system 10. The coupling structure may be reinforced with an O-ring or sealing material in order to prevent air leakage and secure a stable air flow.

In addition, the first duct 100 may include a groove 301 positioned in the dashboard pad 310 and a front pad 320. In an example, the first duct 100 may be positioned in a space between the dashboard pad 310 and the front pad 320 by inserting a portion of the front pad 320 into the groove 301.

The groove 301 constituting the first duct 100 may be positioned on the dashboard pad 310 and may be positioned between the vehicle air conditioning system 10 and the second duct 200 positioned above a vehicle body floor 30.

The groove 301 formed in the dashboard pad 310 extends toward a rear side, i.e., a rear end, in a longitudinal direction of the vehicle. Furthermore, the front pad 320 configured to surround the groove 301 may be positioned on an upper surface of the dashboard pad 310 to maintain the groove 301 in a sealed state with a vehicle interior. The groove 301 in the sealed state constitutes the first duct 100 positioned between a rear discharge vent of the vehicle air conditioning system 10 and the second duct 200.

The front pad 320 positioned on top of the dashboard pad 310 may include a plurality of bridges 321 extending along a rear surface of the dashboard pad 310 in a height direction to bring a portion of the bridges 321 in contact with the upper surface of the dashboard pad 310. The plurality of bridges 321 may extend to pass through an inside of the groove 301 forming the first duct 100.

In addition, the plurality of bridges 321 extends toward the dashboard pad 310 in the height direction of the vehicle. Moreover, some of the plurality of bridges 321 may be in contact with the upper surface of the dashboard pad 310, and the remaining bridges 321 may be inserted into the groove 301 formed in the dashboard pad 310. In an example, the groove 301 means a seating groove 311 into which the plurality of bridges 321 are inserted. Furthermore, some of the multiple bridges 321 are in surface contact with the dashboard pad 310 to support the front pad 320.

The dashboard pad 310 including the plurality of bridges 321 may be formed integrally. The dashboard pad 310 and the bridges 321 may be formed with properties having a predetermined rigidity. Therefore, the dashboard pad 310 including the bridges 321 may secure sufficient rigidity while supported on the dashboard pad 310.

The bridge 321 extending toward the groove 301 and positioned therein may have a width capable of preventing interference of a fluid flowing in the groove 301. A plurality of bridges may be positioned in the groove 301 to maintain a sufficient amount of fluid flowing into the first duct 100.

Through the above structure, the first duct 100 may be formed in a space sealed between the dashboard pad 310 and the front pad 320 by at least some of the plurality of bridges 321 being inserted into the seating groove 311.

In addition, airtightness of the first duct 100 is maintained by a sealing unit 340 surrounding the bridge 321 inserted into the seating groove 311. In an example, the sealing unit 340 may surround a lower end of the bridge 321 inserted into the seating groove 311. When the bridge 321 is inserted into the seating groove 311, since the sealing unit 340 is positioned between the bridge 321 and the seating groove 311, airtightness performance may be maintained in the space between the dashboard pad 310 and the front pad 320. Therefore, while the fluid is sealed, the first duct 100 may be positioned between the vehicle air conditioning system 10 and the second duct 200. The front pad 320 including the bridges 321 surrounds an upper surface of one end of the rear duct 11. The other end of the rear duct 11 is fastened to a vent (not shown) of the vehicle air conditioning system 10.

In addition, a front carpet 330 is in surface contact with an upper surface of the front pad 320, and the front carpet 330 surrounds the front pad 320. In addition, the front carpet 330 surrounds one side surface of the rear duct 11. Through the above structure, the first duct 100 may be fluidly connected to the rear duct 11 while maintaining airtightness with the rear duct 11.

Here, the front carpet 330 and a center carpet 380 may be interpreted as having the same meaning as a finishing material facing the vehicle interior and made of an interior material with the same properties as the pad or an aesthetic feel according to a vehicle application or environment.

In addition, the first duct 100 communicates with the second duct 200 positioned on top of the vehicle body floor 30. In other words, the first duct 100 is positioned between the vehicle air conditioning system 10 and the second duct 200 to fluidly connect the vehicle air conditioning system 10 and the second duct 200.

The second duct 200 communicating with the first duct 100 may be positioned on top of the vehicle body floor 30 to discharge air to a rear seat of the vehicle. Therefore, air performing heat exchange in the vehicle air conditioning system 10 may flow along the first duct 100 and may be introduced into the second duct 200. The air introduced into the second duct 200 may be discharged to upper and lower ends of the rear seat of the vehicle.

In an example, the second duct 200 is connected to the lower end portion of the rear seat of the vehicle, discharges air into a lower space of the rear seat, and discharges the air to an upper portion of the rear seat through a side vent (not shown) of an upper end of the rear seat formed adjacent to left and right C-pillars of the rear seat. In this way, the air is supplied to lower end and upper end regions of the rear seat of the vehicle.

FIG. 2 shows a state in which the dashboard pad 310 is mounted on a front module 400.

As one embodiment of the present disclosure, the vehicle air conditioning system 10 includes the front module 400 in which the dashboard panel 20, the vehicle air conditioning system 10, and the first duct 100 are positioned.

The front module 400 may be manufactured in a block form by considering modular manufacturing. The front module 400 is a part of the body frame, is positioned at a front side of the vehicle, and forms a front structure of the vehicle. In a vehicle with an engine, the engine compartment is positioned on the outer side and includes the vehicle air conditioning system 10 at an inner side based on the dashboard panel 20 of the front module 400 to support a front load of the vehicle.

In addition, the dashboard pad 310 is mounted on the inside of the dashboard panel 20 positioned at a front side of the front module 400. In addition, the vehicle air conditioning system 10 may be positioned inside the dashboard pad 310, and the vehicle air conditioning system 10 may be positioned to pass through the dashboard pad 310 and the dashboard panel 20.

Furthermore, the dashboard pad 310 surrounds an inner side of the front module 400. The dashboard pad 310 extends along an inner side of the dashboard panel 20 toward the vehicle body floor 30 to the rear side, i.e., rear end, in the longitudinal direction of the vehicle. Since the front pad 320 is positioned on the upper surface of the dashboard pad 310 facing a lower end of the front module 400, the first duct 100 may be formed on an upper portion of the lower end of the front module 400.

In other words, the dashboard pad 310 and the vehicle air conditioning system 10 may be positioned in a front inner side of the front module 400. The first duct 100 may be positioned at an upper portion of the lower end of the front module 400.

Furthermore, the front module 400 may be coupled to a center module 500 including the vehicle body floor 30. In an example, the lower end of a rear side of the front module 400 and the lower end of a front side of the center module 500 may be coupled to one another. One surface of the lower end of the rear side of the front module 400 may be in surface contact with the other surface of a lower end of the front side of the center module 500. In an example, an upper surface of the lower end of the front side of the center module 500 may be in surface contact with the lower surface of the lower end of the rear side of the front module 400. The front module 400 and the center module 500 may be mutually fixed through a mechanical fastening structure or an electrical fastening structure.

In this way, when the center module 500 and the front module 400 are assembled at determined positions, the first duct 100 positioned in the front module 400 and the second duct 200 positioned in the center module 500 may communicate.

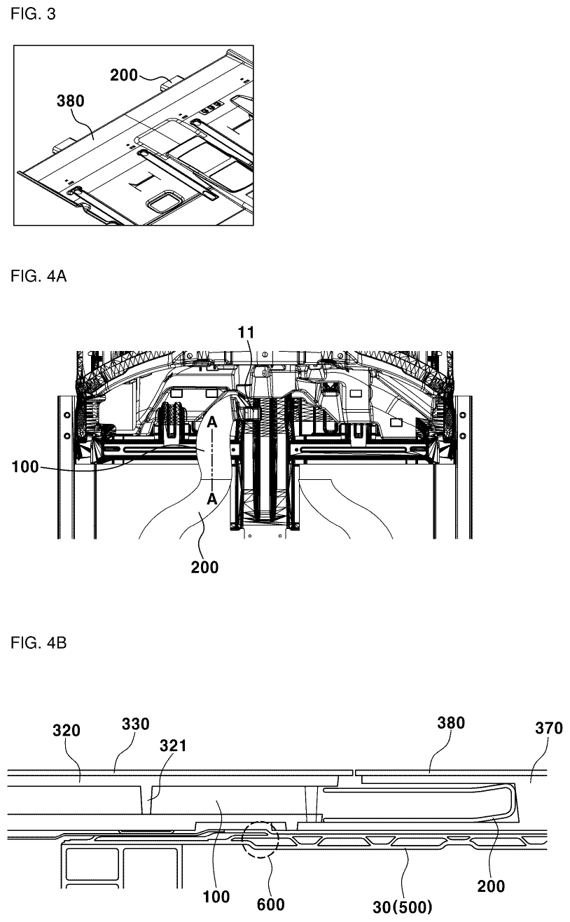

FIG. 3 shows a state in which the center carpet 380 and a center pad 370 are mounted on the center module 500.

As one embodiment of the present disclosure, the center module 500 coupled to the front module 400 includes the vehicle body floor 30 and includes the center pad 370, the second duct 200, and the center carpet 380 on an upper end of the vehicle body floor 30.

The center module 500 includes the vehicle body floor 30 that supports a lower portion of the vehicle. The center pad 370 for absorbing an external impact is mounted on the upper end of the vehicle body floor 30. The center pad 370 is disposed to surround the second duct 200, and the second duct 200 is fluidly connected to the rear seat of the vehicle and the first duct 100 to form an air flow path of the rear seat of the vehicle. The second duct 200 is disposed in a space between the vehicle body floor 30 and the center pad 370 in the center module 500 to protect the air flow path and is designed to distribute air to the upper and lower ends of the rear seat of the vehicle.

In addition, the center carpet 380 is in surface contact with the upper surface of the center pad 370 to finish an inside of an interior space of the vehicle and absorbs vibration and noise generated when the vehicle is traveling.

In addition, the center module 500 may be connected to the front module 400. A structure in which the center module 500 and the front module 400 are connected supports the first duct 100 and the second duct 200 to allow the air discharged from the vehicle air conditioning system 10 to flow smoothly to the rear seat of the vehicle.

FIG. 4A shows a projective view of the first duct 100 and the second duct 200, which are formed in the front module 400 and the center module 500. FIG. 4B shows a side cross-sectional view along line A-A of the ducts in FIG. 4A.

As one embodiment of the present disclosure, one end of the first duct 100 communicates with the rear duct 11, and the other end of the first duct 100 communicates with the second duct 200.

The first duct 100 may extend from the dashboard panel 20 positioned at the front side of the vehicle to the rear side of the vehicle in the longitudinal direction. In addition, the first duct 100 is formed between the dashboard pad 310 and the front pad 320. The shape of the first duct 100 may vary depending on shapes of the dashboard pad 310 and the front pad 320.

Furthermore, the lower end portion of the first duct 100 is in contact with the dashboard pad 310 and the center pad 370, and the upper end portion thereof is in contact with the front pad 320 so that the first duct 100 is fluidly connected to the second duct 200 while maintaining airtightness with the second duct 200.

In an example, a portion of the dashboard pad 310 may be in surface contact with the upper surface of the lower end of the center pad 370 and a front end of the second duct 200. The lower surface of the upper end of the front pad 320 spaced from the dashboard pad 310 surrounds an upper portion of the front end of the second duct 200. With the above structure, the first duct 100 and the second duct 200 communicate.

In addition, the first duct 100 may be positioned on top of the coupling portion 600 between the front module 400 and the center module 500. Here, the coupling portion 600 may be a region where the vehicle body floor (panel) 30 positioned at the front end of the center module 500 and the front floor protruding in a direction facing the center module 500 on both side surfaces of the front module 400 overlap. In addition, the front floor may be positioned in the longitudinal direction of the vehicle where the first duct 100 is formed. In an example, the front floor may protrude in the longitudinal direction relative to the first duct 100 and may be inserted and fixed into the vehicle body floor of the center module.

Furthermore, the dashboard panel 300 may be positioned on the upper surface of the front floor, and the dashboard pad 310 positioned on the upper surface of the dashboard panel 300 may be included. Therefore, the front module 400 may be fastened to the center module 500 to be inserted and positioned inside the center module 500 including the second duct 200. The first duct 100 may be fastened to be fluidly connected to the second duct 200.

In an example, the coupling portion 600 is a region where the front module 400 and the center module 500 are in contact with each other and is formed such that the upper surface of the front end of the center module 500 is in surface contact with the lower surface of the rear end of the front module 400. When the coupling portion 600 is formed at the determined positions of the center module 500 and the front module 400, the dashboard pad 310 is in surface contact with the center pad 370, and the front pad 320 surrounds the front end of the second duct 200 to allow the first duct 100 and the second duct 200 to communicate with each other.

The front carpet 330 in surface contact with the upper surface of the front pad 320 may extend from the dashboard panel 20 in the longitudinal direction of the vehicle and may be positioned to be in contact with one final end of the center carpet 380. In addition, the front carpet 330 is in surface contact with the upper surface of the front pad 320 along a curved shape of the dashboard panel 20. The final end of the front carpet 330 is formed to be in surface contact with the center carpet 380 so that no gap is generated between the carpets.

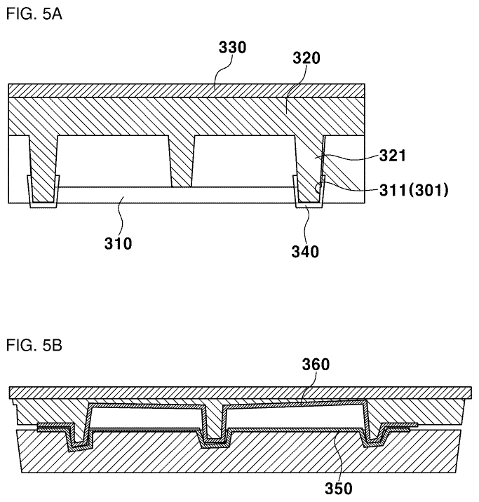

FIG. 5A shows the coupling structure and airtight structure of the dashboard pad 310 and the front pad 320.

As one embodiment of the present disclosure, some of the plurality of bridges 321 are inserted into the seating groove 311 or are in surface contact with the upper surface of the dashboard pad 310 to support the front pad 320. In an example, the bridges 321 in surface contact with the upper surface of the dashboard pad 310 are positioned between the bridges 321 inserted into the seating groove 311. The front pad 320 is positioned apart from the dashboard pad 310 by the bridges 321 in surface contact with the upper surface of the dashboard pad 310. The first duct 100 may be formed between the bridges 321 in surface contact with the upper surface of the dashboard pad 310 and the bridges 321 inserted into the seating groove 311.

Therefore, air passing through the vehicle air conditioning system 10 is introduced into the first duct 100, flows between the bridges 321 in surface contact with the upper surface of the dashboard pad 310 and the bridges 321 inserted into the seating groove 311, and is introduced into the second duct 200.

The front pad 320 and the dashboard pad 310 form the first duct 100 and may be made of a material that provides high durability and impact absorption to support an internal structure of the vehicle.

As one example, the front pad 320 and dashboard pad 310 may be made of expanded polypropylene (EPP), which has excellent impact resistance and excellent resilience even at high temperature. Through the above properties, the front pad 320 may support an external force applied from the vehicle interior. Furthermore, the external force applied to the upper surface of the front pad 320 through the bridges 321 may be distributed to the dashboard pad 310 and the dashboard panel 300.

As another example, the front pad 320 and dashboard pad 310 may be formed in a composite structure of polyurethane (PU) and high-density polyethylene (HDPE). PU provides high elasticity and impact absorption, and HDPE provides rigidity and durability. This composite structure may be designed to maintain stable performance even under an external impact and a repeated vibration and to stably support the first duct 100.

When some of the bridges 321 are inserted into the seating groove 311, the sealing unit 340 surrounding the bridges 321 inserted into the seating grooves 311 is positioned between the bridges 321 and the seating groove 311 to maintain airtightness between the bridges 321 and the seating grooves 311.

Furthermore, the sealing unit 340 may be made of a material having elasticity and durability in order to maintain airtightness of the coupling portion 600 and prevent leakage of an external fluid or air.

In an example, the sealing unit 340 may be made of an elastic material such as ethylene propylene diene monomer (EPDM) or PU. EPDM provides excellent durability, heat resistance, and ozone resistance, and PU has high elasticity and impact resistance, thereby providing a stable sealing between the bridges 321 and the seating grooves 311.

In addition, the sealing unit 340 may be designed with a composite material or multilayer structure to minimize a vehicle driving vibration and material fatigue due to vibration and environmental changes, as necessary.

FIG. 5B shows the coupling structure and airtight structure of the dashboard pad 310 and the front pad 320.

As another embodiment of the present disclosure, a seating groove 311 may be formed to correspond to the number of bridges 321 of a front pad 320 in a dashboard pad 310. Therefore, all the bridges 321 may be inserted into the seating grooves 311. A sealing unit 340 configured to surround a lower end of the bridge 321 may be used to maintain airtightness between the seating groove 311 and the bridge 321.

In addition, in order to maintain airtightness between the seating groove 311 and the bridge 321, a first sealing pad 350 surrounding an upper surface of the dashboard pad 310 and a second sealing pad 360 surrounding a lower surface of the bridge 321 are included. Thus, when the bridge 321 is inserted into the seating groove 311, a first duct 100 is formed between the first sealing pad 350 and the second sealing pad 360. Air introduced into the first duct 100 flows along the first sealing pad 350 and the second sealing pad 360, is introduced into the second duct 200, and is discharged to a rear seat of the vehicle.

The first sealing pad 350 and the second sealing pad 360, which maintain airtightness of the first duct 100, may be made of materials having the same or different properties.

For example, when the first sealing pad 350 and the second sealing pad 360 are made of materials having the same property, the first sealing pad 350 and the second sealing pad 360 may be made of an EPDM or PU pad. EPDM provides excellent durability, heat resistance, and ozone resistance and provides stable sealing performance even after long-term exposure to the environment.

PU provides high elasticity and impact resistance and provides strong characteristics to address repeated vibration and impact.

Alternatively, the first sealing pad 350 and the second sealing pad 360 may be made of materials having different properties that perform a complementary action or function.

For example, the first sealing pad 350 may be made of EPDM, and the second sealing pad 360 may be made of PU. The first sealing pad 350 may be designed to maintain airtightness between the bridge 321 and the seating groove 311. The second sealing pad 360 may be designed to absorb an impact generated when the bridge 321 is inserted into the seating groove 311 and a vibration generated while the vehicle is traveling.

In summary, the present disclosure has technical features of resolving a position limitation of the vehicle air conditioning system 10 and providing increased design flexibility of the air conditioning system. The disclosed air duct and system do so by forming the first duct 100 that communicates the vehicle air conditioning system 10 and the second duct 200 positioned in the front module 400 by utilizing the space between the front pad 320 and the dashboard pad 310.

The present disclosure can obtain the following effects according to a combination of the above-described embodiments and a configuration, which is described below, and a use relationship.

First, by coupling a front module and a center module to form a duct structure, separate duct components are no longer needed in the existing air conditioning system. Thus, effects of simplifying an assembly process and reducing manufacturing costs can be obtained.

Second, by integrating functions of a duct and a pad to optimize the layout inside the vehicle, flatness and low-floor of the vehicle floor can be implemented and an effect capable of improving space utilization and reducing a weight is provided.

Third, the duct structure utilizing the spacing between the carpet portions can reduce heat loss and improve air conditioning performance, thereby providing effects of increasing energy efficiency and enhancing passenger comfort.

The foregoing detailed description illustrates the present disclosure. Further, the foregoing is intended to illustrate and describe various example embodiments of the present disclosure. The various aspects and features of the present disclosure may be used in various other combinations, modifications, and environments. In other words, it is possible to practice alternations or modifications without departing from the scope of the present disclosure, as described in this specification, equivalents, and/or within the technical or scope of knowledge in the art to which the present disclosure pertains. The described embodiments are intended to illustrate example modes for carrying out the technical spirit of the present disclosure and various modifications can be made in the specific applications and uses of the present disclosure. Therefore, the detailed description is not intended to limit the present disclosure to the disclosed embodiments. Further, it should be construed that the appended claims are intended to include additional embodiments.

What is claimed is:

1. A vehicle duct structure, comprising:
a dashboard panel including a dashboard pad;
a front pad positioned to face the dashboard panel;
a vehicle air conditioning system positioned in the dashboard panel;
a first duct configured to communicate with the vehicle air conditioning system; and
a second duct configured to communicate with the first duct and positioned on a vehicle body floor,
wherein the dashboard pad includes a groove positioned between the vehicle air conditioning system and the second duct, and
wherein the first duct includes the groove and the front pad.

2. The vehicle duct structure of claim 1, wherein:
the front pad includes a plurality of bridges extending along the first duct; and
the dashboard pad includes a seating groove into which one or more of the bridges are inserted.

3. The vehicle duct structure of claim 2, further comprising:
a sealing unit configured to surround one or more of the bridges inserted into the seating groove.

4. The vehicle duct structure of claim 3, wherein the sealing unit includes:
a first sealing pad configured to surround an upper surface of the dashboard pad including the seating groove; and
a second sealing pad, at least a portion of which is in contact with the first sealing pad and which surrounds a lower surface of the front pad, including the bridge.

5. The vehicle duct structure of claim 1, further comprising:
a front module where the dashboard panel and the front pad are positioned, wherein the first duct is formed in the front module.

6. The vehicle duct structure of claim 5, further comprising:
a center module including the vehicle body floor and coupled to the front module,
wherein the center module and the front module are coupled to one another so that the first duct and the second duct are fluidly connected.

7. The vehicle duct structure of claim 1, further comprising:
a front carpet in surface contact with the front pad;
a center pad configured to surround the second duct; and
a center carpet in surface contact with the center pad.

8. A vehicle air conditioning system, comprising:
a front module including a dashboard panel; and
a center module including a vehicle body floor and coupled to the front module,
wherein the front module includes
a vehicle air conditioning system positioned in the front module,
a first duct fluidly connected to the vehicle air conditioning system, and
a second duct configured to communicate with the first duct and positioned on a vehicle body floor, and
wherein the first duct is positioned on an upper end of a coupling portion positioned between the front module and the center module.

9. The vehicle air conditioning system of claim 8, wherein the first duct is fluidly connected to the second duct by connecting the front module and the center module.

10. The vehicle air conditioning system of claim 9, wherein the first duct is formed through a spacing between a dashboard pad positioned inside the dashboard panel and the front pad, a portion of which is in surface contact with the dashboard pad.
